(19) United States
(12) Patent Application Publication
(10) Pub. No.: US 2006/0036421 A1
(43) Pub. Date: Feb. 16, 2006

(54) Electromagnetic field simulator, medium for storing electromagnetic field simulation program, and electromagnetic field simulation method

(75) Inventors: Akio Sekino, Kawasaki (JP); Masaki Tosaka, Kawasaki (JP); Yuuji Suwa, Kawasaki (JP); Jirou Yoneda, Kawasaki (JP); Megumi Nagata, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/002,323

(22) Filed: Dec. 3, 2004

(30) Foreign Application Priority Data
Aug. 11, 2004 (JP) 2004-234481

(51) Int. Cl. G06F 17/50

(52) U.S. Cl. 703/13

(57) ABSTRACT

An electromagnetic field simulator of the present invention includes: a search section; a domain setting section; an individual characteristic calculation sections; and a characteristic connection section. The search section searches discontinuous parts having a predetermined discontinuous shape on the conductor wiring. The domain setting section sets an analysis domain including the conductor wiring as a set of simulation domains so that the discontinuous parts as well as the wiring parts in a predetermined range around the discontinuous parts are included in the same simulation domain. The individual characteristic calculation sections calculate the characteristic by simulating the electromagnetic field for each simulation domain set by the domain setting section. The characteristic connection section connects characteristics of the respective simulation domains calculated by the individual characteristic calculation section and calculates a characteristic of the entire conductor wiring.

### BACKGROUND OF THE INVENTION

1. Field of the Invention

The present invention relates to an electromagnetic field simulator which simulates an electromagnetic field of a given conductor wiring structure, a medium for storing an electromagnetic field simulation program which stores an electromagnetic field simulation program which causes a computer to operate as such an electromagnetic field simulator, and an electromagnetic field simulation method in such an electromagnetic field simulator.

2. Description of the Related Art

Conventionally, calculating signal transmission performance, etc., of wiring under design and reflecting the signal transmission performance in the design is a widespread practice and high accuracy design using S parameters (Smith chart) which express the frequency dependency of a line characteristic of wiring is becoming a focus of attention with the use of signals at high frequencies.

One of techniques for calculating such S parameters is a technique of three-dimensionally simulating an electromagnetic field produced by an object such as wiring using an electromagnetic field simulator or electromagnetic field simulation program and analyzing the frequency dependency of the electromagnetic field. As a typical technique for simulating an electromagnetic field using such an electromagnetic field simulator or electromagnetic field simulation program, a finite difference time domain method (FDTD method) is known (e.g., see Japanese Patent Application Laid-Open No. 2003-6181 and “Electromagnetic Field and Antenna Analysis using FDTD Method”, Toru Uno, 1998, Corona Publishing Co., Ltd.). This technique differentiates Maxwell equations which are the basic equations describing a time variation of an electromagnetic field spatially and temporally and keeps track of the time variation of the electromagnetic field. This technique sets grid intervals (steps) used for discretization of space and time to sufficiently small values so as to simulate the time variation of the electromagnetic field in detail. Advantages of such an FDTD method include that the calculation principles are simple so that the calculation speed can be easily increased, a transient electromagnetic characteristic can be evaluated because a time waveform can be calculated in principle and three-dimensional calculations are easily carried out.

However, for example, analyzing an entire wiring board using an FDTD method at a time requires an astronomical machine time and is not realistic. Furthermore, there is another problem that even when the target wiring consists of one wiring conductor, calculating all wiring conductors all at once requires a large analysis space and an enormous time, and therefore it is not possible to obtain S parameters within a realistic time.

The structure of wiring designed and arranged on a wiring board, etc., is seldom linear and in most cases a curved and complicated structure as a whole, while an analysis space based on the FDTD method is rectangular parallelepiped, and therefore the analysis space which includes wiring having a curved structure includes many spatial parts which are unnecessary for an analysis of S parameters. According to the FDTD method, a machine time is generally proportional to the number of grids, and therefore machine time waste increases as the number of parts which are unnecessary for analysis increases, making it impossible to complete simulation within a realistic time.

Such a problem not only occurs when S parameters are calculated but also generally occurs when an electromagnetic characteristic is obtained by simulating an electromagnetic field. Furthermore, this problem not only occurs in a simulation using the FDTD method, but also occurs regardless of the type of method used to simulate the electromagnetic field.

### SUMMARY OF THE INVENTION

The present invention has been made in view of the above circumstances and provides an electromagnetic field simulator capable of obtaining an electromagnetic characteristic within a realistic time, an electromagnetic field simulation program storage medium storing an electromagnetic field simulation program which causes a computer to operate as such an electromagnetic field simulator, and an electromagnetic field simulation method in such an electromagnetic field simulator.

An electromagnetic field simulator of the present invention is an electromagnetic field simulator which calculates an electromagnetic characteristic by simulating an electromagnetic field of conductor wiring given a design structure, including:
a search section which searches discontinuous parts having a predetermined discontinuous shape on the conductor wiring;
a domain setting section which sets simulation domains in such a manner that the whole of a plurality of simulation domains includes the conductor wiring and that the discontinuous parts found by the search section as well as the wiring parts which exist within a predetermined range peripheral to the discontinuous parts are included in the same simulation domain;
an individual characteristic calculation section which calculates the characteristic by simulating the electromagnetic field for each simulation domain set by the domain setting section; and
a characteristic connection section which connects characteristics of the respective simulation domains calculated by the individual characteristic calculation section and calculates a characteristic of the entire conductor wiring.

In order to extract S parameters within a realistic machine time, it is preferable to perform an analysis using a necessary minimum analysis space without including any unnecessary parts and using an FDTD method, etc. As a technique for obtaining such an analysis space, there can be, for example, a technique of constructing an analysis space in two or more small domains along wiring of an analysis target. Simply stated at this time, in the case of wiring designed using, for example, CAD, it is expected that the analysis space can be sufficiently reduced by setting small-scale domains in units of CAD parts. However, as described above, the actual wiring conductor shape is complicated, and therefore a small-scale domain setting in units of simple parts results in electromagnetic inconsistency, etc., causing deterioration of analysis accuracy.

In the electromagnetic field simulator of the present invention, discontinuous parts are searched by the search section, the wiring parts around the discontinuous parts and the discontinuous parts are included in the same small-scale domain (simulation domain), which avoids electromagnetic inconsistency, etc. Then, electromagnetic characteristics are calculated in two or more small-scale domains and the characteristics of the respective domains are finally connected and the characteristic of the entire wiring is obtained. In this way, the electromagnetic field simulator of the present invention can obtain an electromagnetic characteristic within a realistic time accurately.

In the electromagnetic field simulator of the present invention, the search section preferably searches parts where wiring is bent as the discontinuous parts.

The parts where wiring is bent occur as junctures between linear wiring parts in the case of design using CAD, etc., and when simulation domains are simply set in units of parts, parts before and after this bent part are divided into two or more simulation domains. The wiring parts before and after this bent part have electromagnetic influences on each other, generate deviation of the electromagnetic field according to the bending. However, when the parts before and after this bent part are divided into two or more simulation domains, such electromagnetic influences and deviation are not reproduced, resulting in electromagnetic inconsistency.

Adopting the bent parts as the discontinuous parts using the electromagnetic field simulator of the present invention can avoid inconsistency which occurs in the bent parts.

Furthermore, in the electromagnetic field simulator of the present invention, the search section preferably searches parts in which VIAs are provided as the discontinuous part.

In a wiring board which allows wiring among two or more layers, VIAs are used to connect wiring between different layers. The aforementioned electromagnetic inconsistency also occurs around such VIAs.

Adopting the VIA parts as the discontinuous parts in the electromagnetic field simulator of the present invention can avoid inconsistency that would occur in the VIA parts.

Furthermore, in the electromagnetic field simulator of the present invention, the search section preferably searches parts provided with PADs as the discontinuous parts.

The PAD is often provided on the wiring to connect LSI terminals and chip parts and electromagnetic inconsistency as described above also occurs around this PAD.

Adopting the PAD parts as the discontinuous parts in the electromagnetic field simulator of the present invention can avoid inconsistency that occurs in the PAD parts.

An electromagnetic field simulation program storage medium of the present invention is an electromagnetic field simulation program storage medium storing an electromagnetic field simulation program which is incorporated in a computer and causes the computer to calculate an electromagnetic characteristic by simulating the electromagnetic field in conductor wiring given a design structure, constructing in the computer:
a search section which searches discontinuous parts having a predetermined discontinuous shape on the conductor wiring;
a domain setting section which sets simulation domains in such a manner that the whole of a plurality of simulation domains includes the conductor wiring and that the discontinuous parts found by the search section as well as the wiring parts which exist within a predetermined range peripheral to the discontinuous parts are included in the same simulation domain;
an individual characteristic calculation section which calculates the characteristic by simulating the electromagnetic field for each simulation domain set by the domain setting section; and
a characteristic connection section which calculates a characteristic of the whole conductor wiring by connecting the respective simulation domains calculated by the individual characteristic calculation section.

According to the electromagnetic field simulation program of the present invention, it is possible to easily construct components of the electromagnetic field simulator of the present invention using a computer and cause the computer to operate as the electromagnetic field simulator.

In the electromagnetic field simulation program storage medium of the present invention, the search section preferably searches parts where wiring is bent as the discontinuous parts.

Furthermore, in the electromagnetic field simulation program storage medium of the present invention, the search section preferably searches parts in which VIAs are provided as the discontinuous part.

Furthermore, in the electromagnetic field simulation program storage medium of the present invention, the search section preferably searches parts provided with PADs as the discontinuous parts.

The computer system in which the electromagnetic field simulation program of the present invention is incorporated may be constructed of one computer and peripheral devices or may include two or more computers.

Furthermore, elements such as the domain setting section constructed by the electromagnetic field simulation program of the present invention on a computer may be one element constructed of one program part or one element constructed of two or more program parts or two or more elements constructed of one program part. Or actions of these elements may be executed by themselves or may be executed according to instructions given to other program or program parts incorporated in the computer.

An electromagnetic field simulation method of the present invention is an electromagnetic field simulation method of calculating an electromagnetic characteristic by simulating an electromagnetic field of conductor wiring given a design structure, including:
a search step of searching discontinuous parts having a predetermined discontinuous shape on the conductor wiring;
a domain setting step of setting simulation domains in such a manner that the whole of a plurality of simulation domains includes the conductor wiring and that the discontinuous parts found in the search step as well as the wiring parts which exist within a predetermined range peripheral to the discontinuous parts are included in the same simulation domain;
an individual characteristic calculation step of calculating the characteristic by simulating the electromagnetic field for each simulation domain set in the domain setting step; and
a characteristic connection step of calculating a characteristic of the whole conductor wiring by connecting the respective simulation domains calculated in the individual characteristic calculation step.

According to the electromagnetic field simulation method of the present invention, like the electromagnetic field simulator, it is possible to calculate an electromagnetic characteristic at a high degree of accuracy within a practical time.

In the electromagnetic field simulation method of the present invention, the search step may be a step of searching parts where wiring is bent as the discontinuous parts.

Further, in the electromagnetic field simulation method of the present invention, the search step may be a step of searching parts in which VIAs are provided as the discontinuous parts.

Furthermore, in the electromagnetic field simulation method of the present invention, the search step may be a step of searching parts provided with PADs as the discontinuous parts.

As described above, the electromagnetic field simulator, electromagnetic field simulation program storage medium, and electromagnetic field simulation method of the present invention can calculate an electromagnetic characteristic within a practical time.

### BRIEF DESCRIPTION OF THE DRAWINGS

FIG. 1 is an outside perspective view showing a computer to which an embodiment of the present invention is applied;

FIG. 2 is a hardware block diagram of the computer shown in FIG. 1;

FIG. 3 illustrates an embodiment of an electromagnetic field simulation program storage medium of the present invention;

FIG. 4 is a functional block diagram of an embodiment of an electromagnetic field simulator of the present invention;

FIG. 5 is a flow chart showing the main operation of the electromagnetic field simulator;

FIG. 6 is a flow chart showing the sub-processing of setting (modeling) a simulation domain including discontinuous parts;

FIG. 7 is a flow chart showing the sub-processing of unitizing overlapped simulation domains;

FIG. 8 is a flow chart showing the sub-processing of setting (modeling) a simulation domain including linear wiring;

FIG. 9 illustrates an example of a wiring diagram;

FIG. 10 illustrates an example of target wiring to be searched;

FIG. 11 illustrates how a simulation domain is set in each discontinuous part of the target wiring shown in FIG. 10;

FIG. 12 illustrates how a simulation domain is set in each linear wiring part of the target wiring shown in FIG. 11;

FIG. 13 illustrates details of a simulation domain including a wiring bent part; and

FIG. 14 is a schematic view showing connections of S parameters.

### DETAILED DESCRIPTION OF THE INVENTION

With reference now to the attached drawings, an embodiment of the present invention will be explained below.

Here, an example where an electromagnetic field simulation program stored in an embodiment of an electromagnetic field simulation program storage medium of the present invention is incorporated in a computer and executed and an embodiment of an electromagnetic field simulator of the present invention is thereby constructed on the computer will be explained.

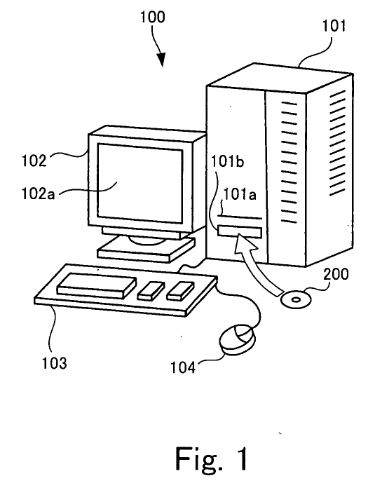

FIG. 1 is an outside perspective view showing a computer to which an embodiment of the present invention is applied;

This computer 100 is provided with a main section 101 which incorporates a CPU, RAM memory and hard disk, etc., a CRT display 102 which displays screens on a fluorescent surface 102a according to instructions from the main section 101, a keyboard 103 for inputting user instructions and character information to this computer and a mouse 104 for indicating an arbitrary position on the fluorescent surface 102a to thereby inputting an instruction corresponding to the position.

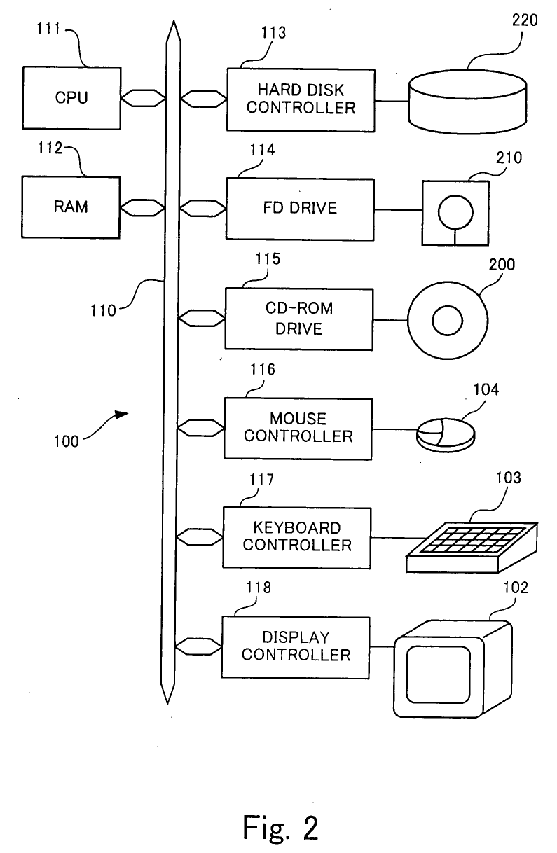

The main section 101 further externally includes a flexible disk 210 (not shown in FIG. 1; see FIG. 2), a flexible disk loading aperture 101a through which a CD-ROM 200 is loaded and a CD-ROM loading aperture 101b and internally includes a flexible disk drive 114 (see FIG. 2) and a CD-ROM drive 115 (see FIG. 2) for driving the loaded flexible disk and CD-ROM 200 respectively.

In this embodiment, the CD-ROM 200 is an embodiment of the electromagnetic field simulation program storage medium of the present invention and this CD-ROM 200 is loaded through the CD-ROM loading aperture 101b into the main section 101 and the electromagnetic field simulation program stored in the CD-ROM 200 is installed by the CD-ROM drive 115 into the hard disk of this computer 100. When the electromagnetic field simulation program installed in the hard disk of this computer 100 is started, an embodiment of the electromagnetic field simulator of the present invention is constructed on this computer 100.

FIG. 2 is a hardware block diagram of the computer shown in FIG. 1.

As shown here, the computer 100 is provided with a central processing unit (CPU) 111, a RAM 112, a hard disk controller 113, a flexible disk drive 114, a CD-ROM drive 115, a mouse controller 116, a keyboard controller 117 and a display controller 118, all of which are mutually connected by a bus 110.

As explained with reference to FIG. 1, the flexible disk drive 114 and CD-ROM drive 115 are loaded with the flexible disk 210 and CD-ROM 200 and access the loaded flexible disk 210 and CD-ROM 200.

Furthermore, the hard disk 220 accessed by the hard disk controller 113, mouse 104 controlled by the mouse controller 116, keyboard 103 controlled by the keyboard controller 117 and CRT display 102 controlled by the display controller 118 are also shown here.

As described above, the CD-ROM 200 stores the electromagnetic field simulation program, the electromagnetic field simulation program is read by the CD-ROM drive 115 from the CD-ROM 200, passed through the bus 110 and stored in the hard disk 220 by the hard disk controller 113. In an actual execution, the electromagnetic field simulation program in the hard disk 220 is loaded into the RAM 112 and executed by the CPU 111.

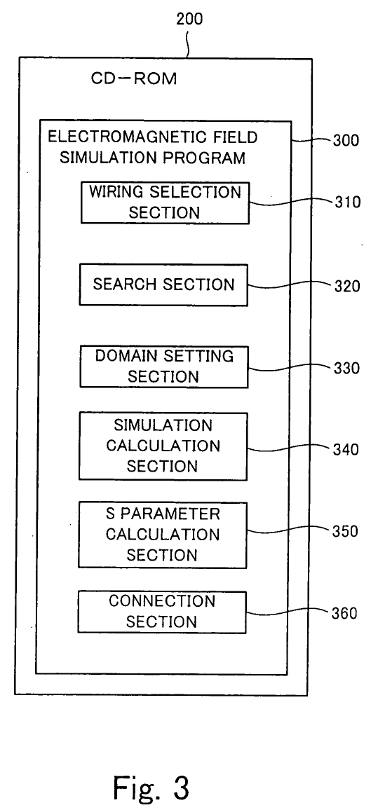

FIG. 3 illustrates an embodiment of the electromagnetic field simulation program storage medium of the present invention. Here, an electromagnetic field simulation program 300 is stored in the CD-ROM 200.

This electromagnetic field simulation program 300 is executed inside the computer 100 shown in FIG. 1 and causes the computer 100 to operate as an electromagnetic field simulator which simulates an electromagnetic field and is provided with a wiring selection section 310, a search section 320, a domain setting section 330, a simulation calculation section 340, an S parameter calculation section 350 and a connection section 360.

Details of the respective elements of this electromagnetic field simulation program 300 will be described later.

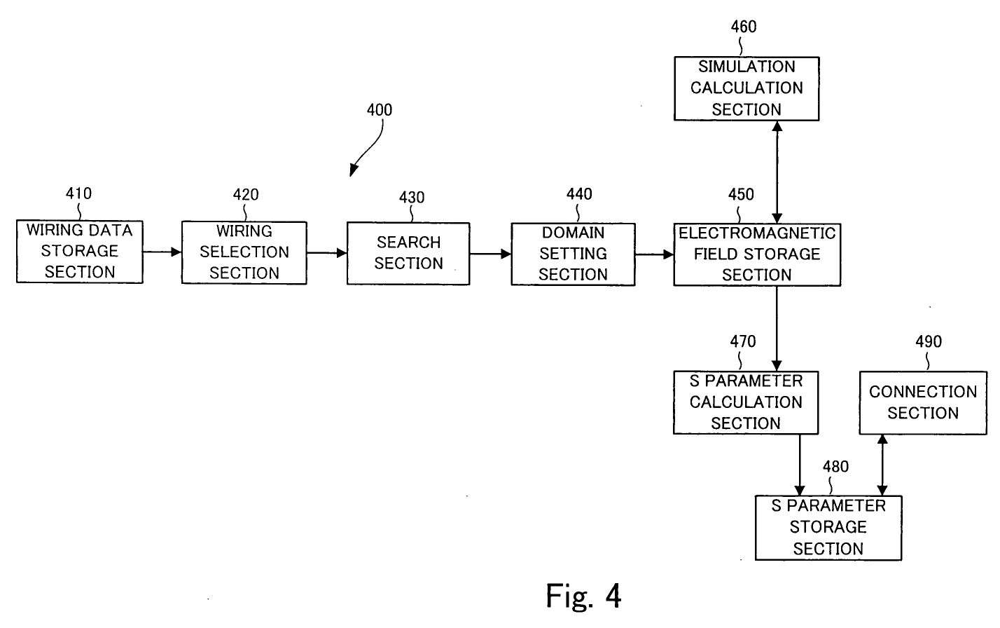

FIG. 4 is a functional block diagram of an embodiment of an electromagnetic field simulator of the present invention.

This electromagnetic field simulator 400 is constructed by the electromagnetic field simulation program 300 in FIG. 3 being installed into and executed by the personal computer 100 shown in FIG. 1.

This electromagnetic field simulator 400 is constructed of a wiring data storage section 410, a wiring selection section 420, a search section 430, a domain setting section 440, an electromagnetic field storage section 450, a simulation calculation section 460, an S parameter calculation section 470, an S parameter storage section 480 and a connection section 490. The wiring selection section 420, search section 430, domain setting section 440, simulation calculation section 460, S parameter calculation section 470 and connection section 490 are constructed by the wiring selection section 310, search section 320, domain setting section 330, simulation calculation section 340, S parameter calculation section 350 and connection section 360 which constitute the electromagnetic field simulation program 300 shown in FIG. 3 on the personal computer 100, respectively. Thus, the respective elements of the electromagnetic field simulator 400 shown in FIG. 4 correspond to the respective elements of the electromagnetic field simulation program 300 shown in FIG. 3. However, there is a difference in that while the elements in FIG. 4 are constructed of a combination of the hardware of the personal computer 100 shown in FIG. 1 and an OS and application program executed by the personal computer, the elements shown in FIG. 3 are constructed of only an application program.

The function of the electromagnetic field storage section 450 is carried out by a so-called main storage unit (RAM 112 shown in FIG. 2) and the functions of the wiring data storage section 410 and S parameter storage section 480 are carried out by a so-called secondary storage unit (hard disk 220 and flexible disk drive 114, etc., shown in FIG. 2).

Of the components of the electromagnetic field simulator 400, the search section 430 corresponds to an example of the search section of the present invention and the domain setting section 440 corresponds to an example of the domain setting section of the present invention. Furthermore, the simulation calculation section 460 and S parameter calculation section 470 constitute an example of the individual characteristic calculation section of the present invention and the connection section 490 corresponds to an example of the characteristic connection section of the present invention.

This electromagnetic field simulator 400 simulates an electromagnetic field of the wiring on the wiring board designed using CAD, etc., and calculates S parameters that correspond to an example of the electromagnetic characteristic of the present invention. Hereafter, the respective components will be explained first and then the operation of the electromagnetic field simulator 400 will also be explained in detail using a specific example.

The wiring data storage section 410 stores shape data expressing a designed wiring shape and the wiring selection section 420 selects a wiring line for which S parameters are to be calculated from among many wiring lines arranged on the wiring board in response to a selection operation by the keyboard 103 or mouse 104 shown in FIG. 1 and FIG. 2.

The search section 430 searches discontinuous parts of the present invention on the selected wiring line and the domain setting section 440 sets two or more simulation domains so that the aforementioned electromagnetic inconsistency is avoided based on the found discontinuous parts. The electromagnetic field storage section 450 is provided with three-dimensional array variables for storing the electromagnetic field of the set simulation domain.

The simulation calculation section 460 simulates the electromagnetic field for each simulation domain using the aforementioned FDTD method and updates the values of the three-dimensional array variables of the electromagnetic field storage section 450.

The S parameter calculation section 470 calculates S parameters for each simulation domain based on the simulated electromagnetic field and the S parameter storage section 480 stores the calculated S parameters.

The connection section 490 connects the calculated S parameters for each simulation domain and calculates an S parameter representing the characteristic of the entire selected wiring.

Details of the operation of the electromagnetic field simulator 400 will be explained using a flow chart and specific example below.

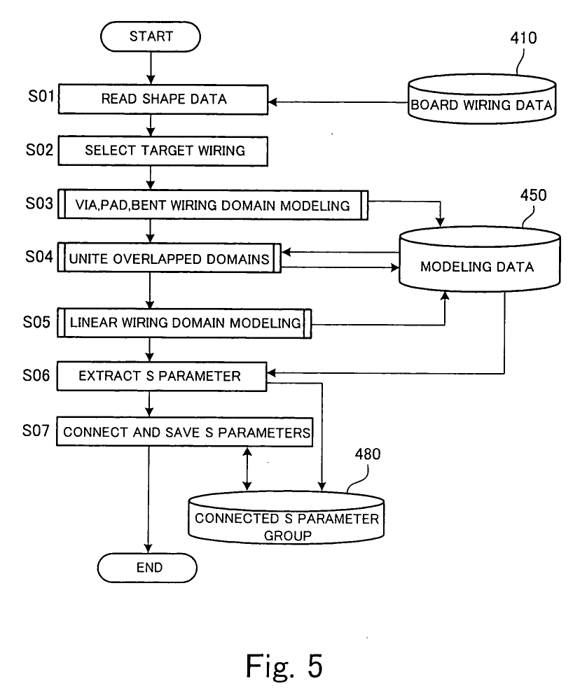

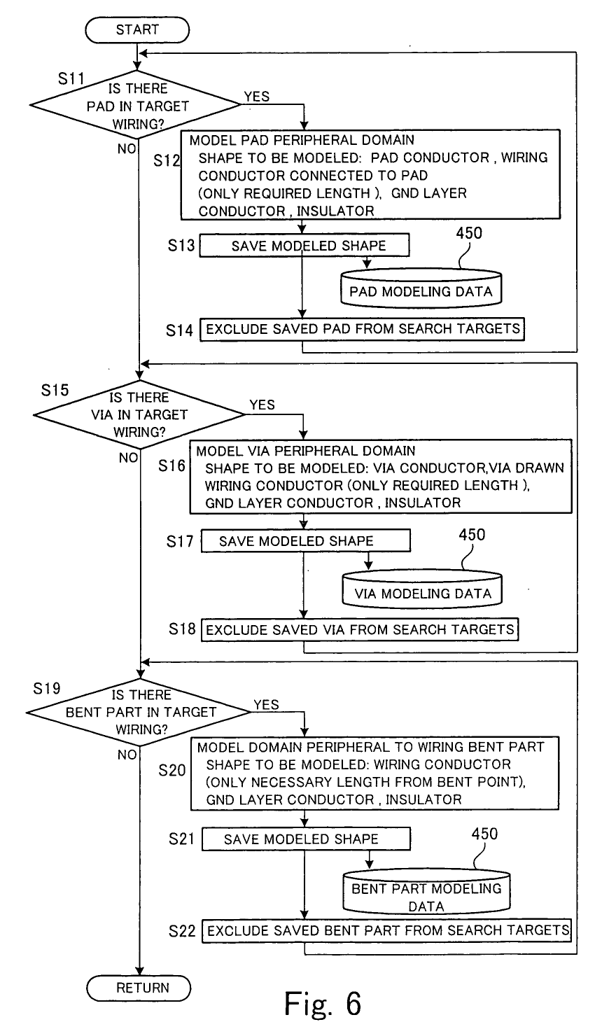

FIG. 5 is a flow chart showing the main operation of the electromagnetic field simulator and FIGS. 6 to 8 are flow charts showing sub-processing in the main operation.

For convenience of explanation, FIG. 5 shows the wiring data storage section 410, electromagnetic field storage section 450 and S parameter storage section 480 which are shown in FIG. 4.

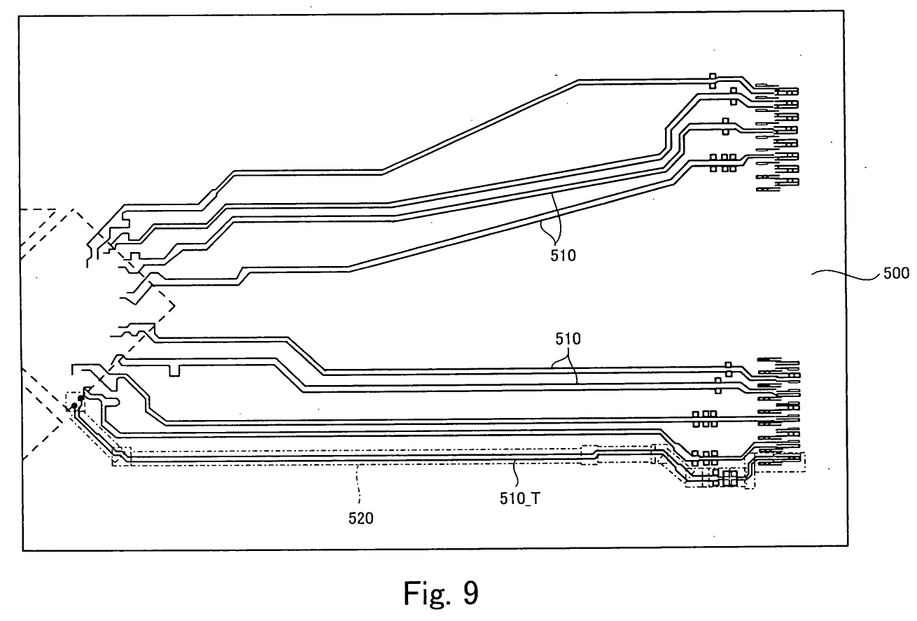

FIGS. 9 to 14 will be referred to in explaining these flow charts below as appropriate.

When the main operation of the electromagnetic field simulator is started, the shape data expressing the wiring shape on the wiring board designed using CAD, etc., is loaded from the wiring data storage section 410 into the wiring selection section 420 shown in FIG. 4 first (step S01 in FIG. 5). The wiring selection section 420 displays a wiring diagram on the CRT display 102 shown in FIG. 1 and FIG. 2.

FIG. 9 illustrates an example of the wiring diagram displayed.

As shown in this FIG. 9, many wiring lines 510 are generally arranged on the wiring board 500. When S parameters are calculated by the electromagnetic field simulator, one target wiring line 510_T is selected from among these wiring lines 510 through the user's operation. That is, the wiring selection section 420 shown in FIG. 4 selects the target wiring line 510-T in response to a selection operation by the keyboard 103 or mouse 104 shown in FIG. 1 and FIG. 2 (step S02 in FIG. 5). Thus, when the target wiring line 510_T is selected, the analysis domain 520 along the target wiring line 510_T is automatically set by the electromagnetic field simulator.

A wiring shape can be divided into a portion whose sectional shape is uniformly continuous and a portion whose sectional shape is discontinuous. First, the discontinuous portion on the target wiring line 510_T is searched by the search section 430 shown in FIG. 4 and a small-scale domain (simulation domain) which includes the found discontinuous parts individually is set by the domain setting section 440 (step S03 in FIG. 5). The electromagnetic field storage section 450 provides three-dimensional array variables for storing data of the electromagnetic field corresponding to the set simulation domain and sets (models) distributions of dielectric constant and magnetic permeability, etc., corresponding to the material arrangement in the simulation domain. The sub-processing in this step S03 will be described in detail later.

When the simulation domain setting on all the discontinuous parts found on the target wiring line is completed, then the overlapped simulation domains of those simulation domains are united by the domain setting section 440 shown in FIG. 4 and three-dimensional array variables, etc., of the electromagnetic field storage section 450 are corrected (step S04). Details of the sub-processing in this step S04 will also be described later.

When the overlapped simulation domains have been united, the domain setting section 440 shown in FIG. 4 sets a simulation domain including the remaining linear wiring part (continuous part) and the electromagnetic field storage section 450 provides the three-dimensional array variable corresponding to the simulation domain and sets (models) distributions of dielectric constant and magnetic permeability (step S05). Details of the sub-processing in this step S05 will also be described later.

In these steps S03 to S05, as shown in FIG. 9, two or more simulation domains including the target wiring line 510_T as a whole which constitute an analysis domain 520 along the target wiring line 510_T are set. About the respective simulation domains, the simulation calculation section 460 shown in FIG. 4 performs electromagnetic field simulations and the S parameter calculation section 470 calculates S parameters of the respective simulation domains based on the simulation result (step S06). The calculated S parameters are stored in the S parameter storage section 480. The S parameters of the respective simulation domains calculated in this way are connected by the connection section 490 shown in FIG. 4 and an S parameter representing the characteristic of the entire target wiring is obtained (step S07) and the S parameter is also stored in the S parameter storage section 480. With regard to the S parameter, it is known that the completely the same S parameter as the S parameter obtained when the entire wiring is simulated is obtained by connecting the S parameters in the respective wiring parts through predetermined calculation processing and the calculation processing for such connection is also known.

Each simulation domain is set so as to be reduced to the smallest possible size within the limit necessary for the simulation and the S parameter of each domain is calculated in a sufficiently short time. The analysis domains constructed in these simulation domains are also analysis domains in the so-called minimum necessary size and an S parameter corresponding to the entire target wiring is also calculated within a practical time.

Details of the sub-processing, explanations of which have been postponed, will be explained using specific examples.

FIG. 6 is a flow chart showing the sub-processing of setting (modeling) a simulation domain including discontinuous parts.

This sub-processing is the sub-processing which is executed in step S03 in FIG. 5.

In this embodiment, more specifically, the VIA part, PAD part and part in which wiring is bent are searched as discontinuous parts and this sub-processing searches the PAD part, VIA part and bent part in that order.

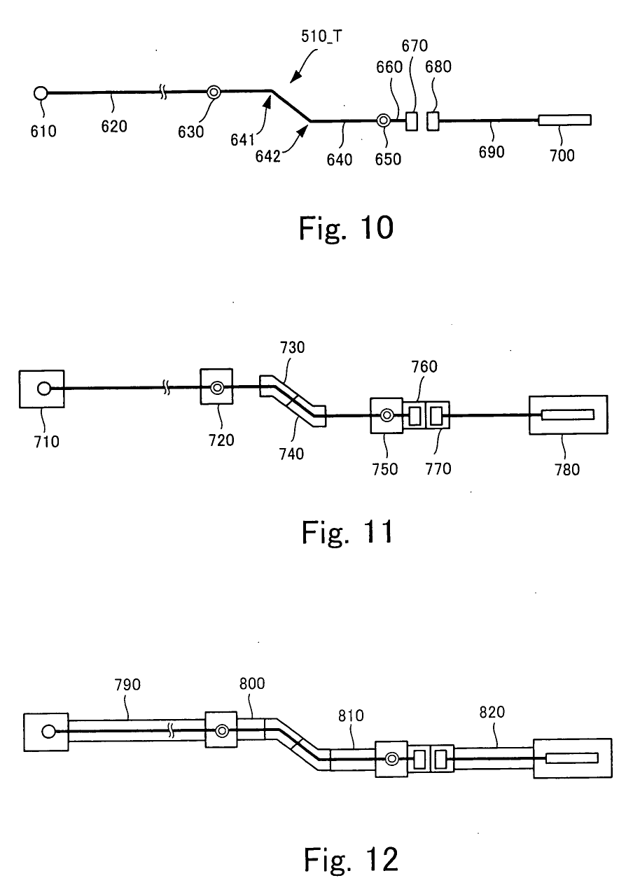

FIG. 10 illustrates an example of the target wiring to be searched.

This FIG. 10 shows a target wiring line 510_T constructed of an LSI terminal PAD 610, surface layer wiring 620, VIA 630 connecting the surface layer and inner layer, inner layer wiring 640 having two bent parts 641, 642, VIA 650 connected to the inner layer wiring 640, surface layer wiring 660, two chip parts PADs 670, 680, surface layer wiring 690 connected to the PAD 680 and LSI terminal PAD 700.

On this target wiring line 510_T, four PADs 610, 670, 680, 700 and two VIAs 630, 650 and two bent parts 641, 642 constitute discontinuous parts.

When the sub-processing shown in FIG. 6 is started, the search section 430 shown in FIG. 4 analyzes shape data of the target wiring and searches the PAD parts first (step S11) The search section 430 searches the PADs from one end along the target wiring line 510-T as shown in FIG. 10. When a PAD is found (step S11 in FIG. 6: Yes), the peripheral domain including the PAD is modeled as the simulation domain (step S12). As the modeling target, the conductor constituting the PAD and a portion corresponding to a predetermined length of the wiring conductor connected to the PAD are extracted from the shape data of the target wiring. Furthermore, not only those wiring conductors but also a GND layer and insulating layer making up the wiring board have electromagnetic influences, and therefore they are modeled. The shapes of these modeled conductors are saved in the electromagnetic field storage section 450 (step S13) and the saved PADs are excluded from the targets to be searched by the search section 430 (step S14).

Then, the program goes back to step S11 and executes operations in steps S11 to S14 repeatedly until all PADs are found.

When there are no more PADs as search targets (step S11: No), the search section 430 shown in FIG. 4 analyzes shape data and searches VIA parts (step S15). When a VIA is found (step S15: Yes), peripheral domains including the VIA are modeled as simulation domains (step s16). As the modeling targets, conductors constituting the VIA and a portion corresponding to a predetermined length of the wiring conductor drawn out of the VIA are extracted from the shape data of the target wiring. The GND layer and insulating layer are also modeling targets here. The shapes of the conductors modeled in this way are saved in the electromagnetic field storage section 450 (step S17) and the saved VIAs are excluded from the targets to be searched by the search section 430 (step S18).

Then, the program goes back to step S15 and executes the operations in steps S15 to S18 repeatedly until all VIAs are found.

When there are no more VIAs as search targets (step S15: No), the search section 430 shown in FIG. 4 analyzes the shape data and searches wiring bent parts corresponding to junctures between linear wiring parts (step S19). When a wiring bent part is found (step S19: Yes), peripheral domains including the wiring bent part are modeled as a simulation domain (step S20). As the modeling targets, a portion corresponding to a predetermined length from the bent point (that is, juncture) of the wiring conductor is extracted from the shape data of the target wiring and GND layer and insulating layer also become modeling targets. The shapes of conductors modeled in this way are saved in the electromagnetic field storage section 450 (step S21) and the saved wiring bent parts are excluded from the targets to be searched by the search section 430 (step S22).

Then, the program goes back to step S19 and executes operations in steps S19 to S22 repeatedly until all the wiring bent parts are found and when there are no more wiring bent parts as the search targets (step S19: No), the sub-processing shown in this FIG. 6 is finished.

FIG. 11 illustrates how a simulation domain is set for each discontinuous part of the target wiring shown in FIG. 10.

As shown in this FIG. 11, with regard to the respective discontinuous parts on a target wiring, domains including wiring peripheral to the discontinuous parts are set as simulation domains 710, . . . , 780. Thus, when simulation domains including wiring peripheral to the discontinuous parts are also set, electromagnetic inconsistency in discontinuous parts is avoided and it is possible to realize simulations at a high degree of accuracy.

In this FIG. 11, the two simulation domains 730, 740 including the wiring bent parts are shown just like a domain of a distorted shape, but these simulation domains 730, 740 are actually also rectangular parallelepiped domains.

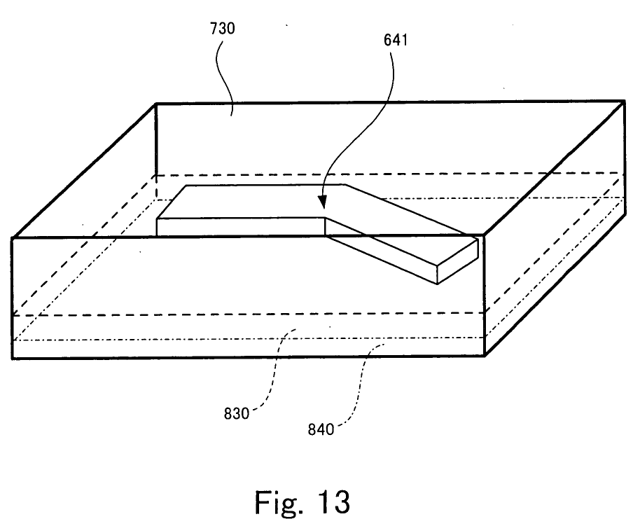

FIG. 13 shows details of a simulation domain including wiring bent parts.

A simulation domain 730 including a bent part 641 has a rectangular parallelepiped shape and this simulation domain 730 also includes an insulating layer 830 on which a conductor is mounted and a GND layer 840 provided below the insulating layer 830.

The sub-processing shown in FIG. 6 sets a simulation domain including the discontinuous parts using the procedure described above.

Next, the sub-processing of uniting overlapped simulation domains will be explained.

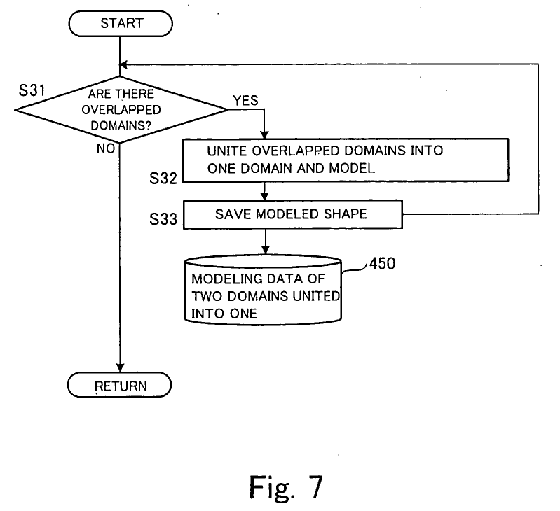

FIG. 7 is a flow chart showing the sub-processing of uniting overlapped simulation domains.

When simulation domains are set on the respective discontinuous parts through the sub-processing shown in FIG. 6, the wiring parts connected peripherally to the discontinuous parts in particular may extend over two or more simulation domains. In this case, the simulation domains in this condition overlap with each other, causing inconvenience when S parameters are finally connected, and therefore it is necessary to unite those overlapped simulation domains beforehand.

When the sub-processing shown in FIG. 7 is started, the domain setting section 440 shown in FIG. 4 searches those modeled and overlapped simulation domains (step S31) and when overlapped simulation domains are found (step S31: Yes), a new one rectangular parallelepiped simulation domain including all conductors included in the respective overlapped domains is set and the insulating layer and GND layer are also newly modeled (step S32). The shapes of the conductors, etc., modeled in this way are saved in the electromagnetic field storage section 450 (step S33) and the program goes back to step S31 and repeats the above procedure. When there are no more overlapped simulation domains (step S31: No), the sub-processing shown in this FIG. 7 is finished.

Next, the sub-processing of setting simulation domains including linear wiring will be explained.

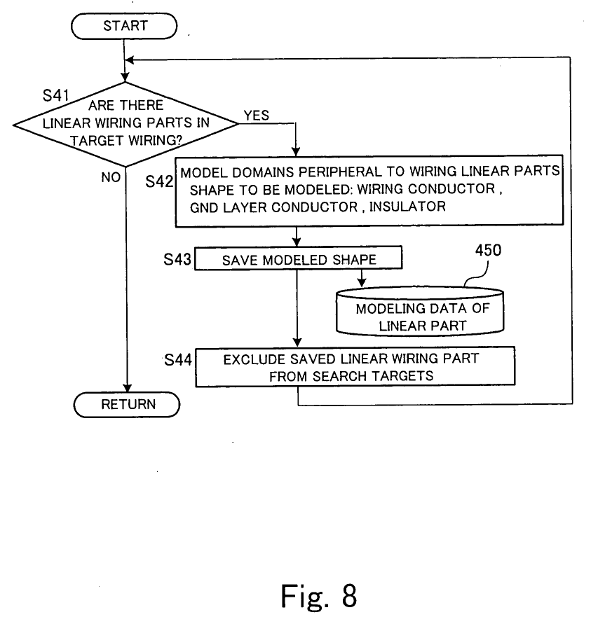

FIG. 8 is a flow chart showing the sub-processing of setting (modeling) a simulation domain including linear wiring.

When the sub-processing shown in FIG. 6 and the sub-processing shown in FIG. 7 are completed, the remaining parts of the target wiring which have not been included in the simulation domain are all linear wiring parts. In the sub-processing shown in FIG. 8, simulation domains are set for these linear wiring parts.

When the sub-processing shown in FIG. 8 is started, the domain setting section 440 shown in FIG. 4 analyzes the shape data of the target wiring and searches the wiring part in which no simulation domain has been set (that is, linear wiring part) sequentially from the end of the target wiring (step S41). When the linear wiring part is found (step S41: Yes), the simulation domain including the linear wiring part is modeled and the GND layer and insulating layer also become modeling targets (step S42). The modeled shape is saved in the electromagnetic field storage section 450 (step S43) and the saved linear wiring parts are excluded from the search targets (step S44).

Then, the program goes back to step S41 and executes the operations of steps S41 to S44 repeatedly until all the linear wiring parts are found. When there are no more linear wiring parts as the search targets and simulation domains have been set over the entire target wiring (step S41: No), the sub-processing shown in this FIG. 8 is completed.

FIG. 12 illustrates how the simulation domains are set for the linear wiring parts of the target wiring shown in FIG. 11.

In this FIG. 12, simulation domains 790, 800, 810 and 820 are also set for the wiring parts which have remained without any simulation domain being set therein in FIG. 11. As a result, a total of 12 simulation domains are set for the target wiring and these 12 simulation domain as a whole constitute an analysis domain including the target wiring. The analysis domain constructed in this way can be limited to the minimum necessary size for the analysis of S parameters, and therefore the calculation time required for a simulation is also a minimum necessary time, allowing an analysis within a practical time. Furthermore, when individual simulation domains are compared, simulation domains having completely the same model structure can be produced. For two or more simulation domains having the same model structure, if only one simulation domain is subjected to a simulation or analysis, it is possible to omit simulations, etc., for other simulation domains, and therefore further reduction of the calculation time can be expected.

Finally, connections of S parameters calculated for such simulation domains will be explained.

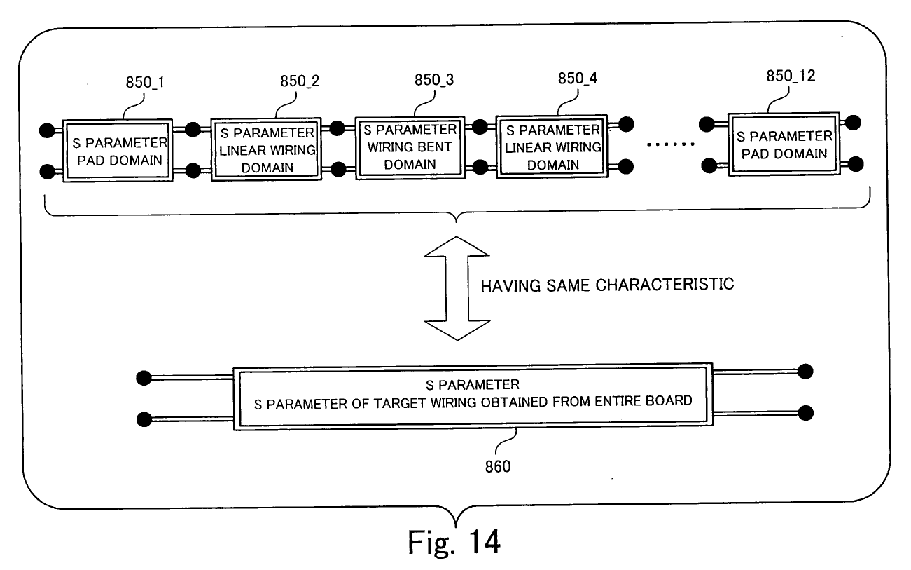

FIG. 14 is a schematic view illustrating connections of S parameters.

When S parameters 850_1, 850_2, 850_3, 850_4, . . . , 850_12 calculated for the respective simulation domains set on the target wiring are combined in the same order as that on the target wiring, the combined parameter has completely the same characteristic as that of the S parameter 860 which is obtained when the entire target wiring is simulated by one simulation domain. Therefore, by using the analysis domain that is constructed of two or more simulation domains as described above, even a large scale wiring model can maintain the analysis accuracy and shorten the analysis time simultaneously.

The above explanations show an example of the search section that searches VIAs, PADs and bent parts, but the search section of the present invention may also search discontinuous parts of other types.

Furthermore, the above explanations illustrate as an example an electromagnetic field simulation program that is already provided with the simulation calculation section which carries out a simulation function in the individual characteristic calculation section of the present invention, too. But the electromagnetic field simulation program of the present invention may also construct an individual characteristic calculation section on a computer using the function of a simulation calculation program, etc., other than the own simulation program.

What is claimed is:

1. An electromagnetic field simulator which calculates an electromagnetic characteristic by simulating an electromagnetic field of conductor wiring given a design structure, comprising:
a search section which searches discontinuous parts having a predetermined discontinuous shape on the conductor wiring;
a domain setting section which sets simulation domains in such a manner that the whole of a plurality of simulation domains includes the conductor wiring and that the discontinuous parts found by the search section as well as the wiring parts which exist within a predetermined range peripheral to the discontinuous parts are included in the same simulation domain;
an individual characteristic calculation section which calculates the characteristic by simulating the electromagnetic field for each simulation domain set by the domain setting section; and
a characteristic connection section which calculates a characteristic of the whole conductor wiring by connecting the respective simulation domains calculated by the individual characteristic calculation section.

2. The electromagnetic field simulator according to claim 1, wherein the search section searches parts where wiring is bent as the discontinuous parts.

3. The electromagnetic field simulator according to claim 1, wherein the search section searches parts in which VIAs are provided as the discontinuous parts.

4. The electromagnetic field simulator according to claim 1, wherein the search section searches parts provided with PADs as the discontinuous parts.

5. An electromagnetic field simulation program storage medium storing an electromagnetic field simulation program which is incorporated in a computer and causes the computer to calculate an electromagnetic characteristic by simulating the electromagnetic field in conductor wiring given a design structure, comprising in the computer:
a search section which searches discontinuous parts having a predetermined discontinuous shape on the conductor wiring;
a domain setting section which sets simulation domains in such a manner that the whole of a plurality of simulation domains includes the conductor wiring and that the discontinuous parts found by the search section as well as the wiring parts which exist within a predetermined range peripheral to the discontinuous parts are included in the same simulation domain;
an individual characteristic calculation section which calculates the characteristic by simulating the electromagnetic field for each simulation domain set by the domain setting section; and
a characteristic connection section which calculates a characteristic of the whole conductor wiring by connecting the respective simulation domains calculated by the individual characteristic calculation section.

6. The electromagnetic field simulation program storage medium according to claim 5, wherein the search section searches parts where wiring is bent as the discontinuous parts.

7. The electromagnetic field simulation program storage medium according to claim 5, wherein the search section searches parts in which VIAs are provided as the discontinuous parts.

8. The electromagnetic field simulation program storage medium according to claim 5, wherein the search section searches parts provided with PADs as the discontinuous parts.

9. An electromagnetic field simulation method of calculating an electromagnetic characteristic by simulating an electromagnetic field of conductor wiring given a design structure, comprising:
a search step of searching discontinuous parts having a predetermined discontinuous shape on the conductor wiring;
a domain setting step of setting simulation domains in such a manner that the whole of a plurality of simulation domains includes the conductor wiring and that the discontinuous parts found in the search step as well as the wiring parts which exist within a predetermined range peripheral to the discontinuous parts are included in the same simulation domain;
an individual characteristic calculation step of calculating the characteristic by simulating the electromagnetic field for each simulation domain set in the domain setting step; and
a characteristic connection step of calculating a characteristic of the whole conductor wiring by connecting the respective simulation domains calculated in the individual characteristic calculation step.

10. The electromagnetic field simulation method according to claim 9, wherein the search step is a step of searching parts where wiring is bent as the discontinuous parts.

11. The electromagnetic field simulation method according to claim 9, wherein the search step is a step of searching parts in which VIAs are provided as the discontinuous parts.

12. The electromagnetic field simulation method according to claim 9, wherein the search step is a step of searching parts provided with PADs as the discontinuous parts.
